(19) United States
(12) Patent Application Publication
(10) Pub. No.: US 2026/0168639 A1
(43) Pub. Date: Jun. 18, 2026

(54) PRIMARY OPTICS FOR A LIGHT MODULE OF A VEHICLE HEADLAMP

(71) Applicant: ZKW Group GmbH, Wieselburg (AT)

(72) Inventor: Tobias KARAS, Leiben (AT)

(73) Assignee: ZKW Group GmbH, Wieselburg (AT)

(21) Appl. No.: 19/416,680

(22) Filed: Dec. 11, 2025

(30) Foreign Application Priority Data
Dec. 17, 2024 (EP) 24220708.2

(51) Int. Cl. F21S 41/20; F21S 41/32

(52) U.S. Cl. CPC F21S 41/285; F21S 41/322

(57) ABSTRACT

A primary optics (10) for a vehicle headlamp, the primary optics (10) configured to contribute in irradiate a homogenous segmented light distribution (LD), wherein the segmented light distribution (LD) is formed from at least two light segments (LS1, LS2, LS3) arranged next to each other along a straight line (SL), wherein the primary optics (10) comprises:
at least two light forming devices (200) on a light entry side (110) of a base body (100) for forming the light segments (LS1, LS2, LS3) of the segmented light distribution (LD), wherein each light forming device (200) has a light input section (210), into which light of at least one light source (50) can be coupled into the light forming device (200), wherein each light forming device (200) corresponds to a respective light segment of the segmented light distribution (LD),
wherein the light segments (LS1, LS2, LS3) in the segmented light distribution (LD) are arranged next to each other in such a way that directly adjacent light segments (LS1, LS2, LS3) adjoin each other in a non-overlapping manner in a boundary area, wherein at least one light forming device (200) comprises at least one homogenization section (220) configured to direct part of the light coupled into the respective light forming device (200) to the boundary area of the light segments (LS1, LS2, LS3) of the segmented light distribution (LD) in form of a homogenization segment (HS1, HS2), in order to generate a homogenous segmented light distribution (LD).

The invention relates to a primary optics for a light module of a vehicle headlamp, the primary optics is a non-imaging primary optics configured to contribute in irradiate a homogenous segmented light distribution in front of the primary optics, wherein the segmented light distribution is formed from at least two light segments arranged next to each other along a straight line, wherein the primary optics comprises:
a base body comprising a light entry side, which is configured to receive light from at least one light source and to couple the received light into the base body, and a light output side, which is configured to couple out light coupled into the base body via the light entry side in a main radiation direction,
at least two light forming devices on the light entry side of the base body for forming the light segments of the segmented light distribution, wherein each light forming device has a light input section, into which light of at least one light source can be coupled into the light forming device, wherein each light forming device corresponds to a respective light segment of the segmented light distribution,
wherein the light segments in the segmented light distribution are arranged next to each other in such a way that directly adjacent light segments adjoin each other in a non-overlapping manner in a boundary area.

Further, the invention relates to a light module for a vehicle headlamp comprising
at least one primary optics according to the invention,
a plurality of light sources, at least one light source being associated with a respective light input section of a light forming device, and
a projection lens system, which is configured to receive the light emitted from the light output side of the primary optics and to project the segmented light distribution in front of the light module in the main radiation direction.

Further, the invention relates to a vehicle headlamp comprising at least one light module according to the invention or at least one primary optics according to the invention.

In the field of motor vehicle headlamps, projection modules are widely used to generate and shape light patterns for road illumination. These modules typically employ multiple LEDs arranged side by side, with each LED paired with a collimator to direct light into a light guide or onto a projection lens. Conventional designs focus on achieving a broad light pattern while maintaining uniform illumination across the projection area.

However, one common challenge is ensuring the homogeneity of the light pattern, particularly at the transitions between individual collimators. In many existing systems, sharp edges or abrupt intensity changes at these transition zones or boundary area result in visible artifacts, such as streaks or discontinuities, in the overall light pattern. Such issues can negatively impact the visual appearance and functional performance of the headlamp, necessitating additional measures or more complex optical designs to mitigate these effects.

Despite various approaches to address this problem, current solutions often require a higher number of LEDs or involve complex optical geometries, leading to increased manufacturing costs and energy consumption. Consequently, there remains a need for more efficient designs that can produce wide, homogeneous light patterns with fewer LEDs and smoother transitions between optical elements.

For example, the light segments overlap in the boundary area. However, their superposition shows vertical variation in the light distribution.

It is therefore an object of the invention to provide an enhanced primary optics for a vehicle headlamp.

To achieve this object the at least one light forming device comprises at least one homogenization section configured to direct part of the light coupled into the respective light forming device to the boundary area of the light segments of the segmented light distribution in form of a homogenization segment, in order to generate a homogenous segmented light distribution.

The term “homogenous segmented light distribution” means uniform superposition of at least two adjacent light segments (LSᵢ)+(LSᵢ₊₁), wherein no vertical artifacts or inhomogeneities are present at least in the boundary area.

Advantageously, the segmented light distribution is a low beam or high beam.

The term “segmented light distribution” is to be understood that the light distribution is formed by a at least two or a plurality of light segments which form a contiguous illumination pattern without dark areas with no light in between.

Advantageously, the primary optics comprises a plurality of light forming devices.

Advantageously, each light forming device comprises at least one homogenization section.

Advantageously, the light forming devices are aligned next to each other along at least one straight aligning line on the light entry side of the base body. Advantageously, there are at least two groups of light forming devices, each group is aligned along a straight aligning line. Preferably, all straight aligning lines are parallel to each other, preferably seen in the main radiation direction.

Advantageously, the at least one straight aligning line and the straight line are parallel to each other.

Advantageously, the homogenization section comprises a structure formed of a plurality of grooves parallel to each other, wherein each of the grooves extends along an extension line which is substantially orthogonal to the aligning line.

In other words, seen in the main radiation direction, the extension lines are orthogonal to the aligning line.

Advantageously, the plurality of grooves of the homogenization section of each light forming device are arranged next to each other in such a way that the grooves together form a sinusoidal shape.

Advantageously, the light input section of each light forming device is—seen in the main radiation direction—symmetrical about at least a first symmetry axis.

Advantageously, the light input section of each light forming device is—seen in the main radiation direction—symmetrical about a second symmetry axis, wherein the second symmetry axis is orthogonal to the first symmetry axis.

Advantageously, the homogenization section of each light forming device is disposed—seen in a correct installed primary optics in a vehicle headlamp—on a lower side of the first symmetry axis.

Advantageously, the at least one homogenization section of a light forming device is configured to direct the homogenization segment in a boundary area of light segments which is adjacent to the corresponding light segment of the respective light forming device along the straight line, wherein preferably the straight line is horizontally in a correct installed state of the primary optics in a vehicle headlamp.

Advantageously, the light forming devices are built as TIR optics (TIR=Total Internal Reflection) or collimator lens. In this case, light coupled into the light forming device which is not deflected by the homogenization section is radiated parallel out of the light exit side of the primary optics. In case of collimating lens, the collimation or light forming is done by refraction.

Advantageously, the primary optics is created as a single pieced component by way of molding, in particular injection molding.

The object is also achieved by a light module for a vehicle headlamp comprising
at least one primary optics according to the invention,
a plurality of light sources, at least one light source being associated with a respective light input section of a light forming device, and
a projection lens system, which is configured to receive the light emitted from the light output side of the primary optics and to project the segmented light distribution in front of the light module in the main radiation direction.

The object is also achieved by a vehicle headlamp comprising at least one light module according to the invention or at least one primary optics according to the invention ....

### DESCRIPTION OF THE DRAWINGS

In the following, in order to further demonstrate the present invention, illustrative and non-restrictive embodiments are discussed, as shown in the drawings, which show:

FIG. 1 a schematic cross section of an exemplary primary optics, which is radiation a segmented light distribution in front of the primary optics in a main radiation direction, wherein the primary optics comprises a plurality of TIR optics as light forming devices;

FIG. 2 a back view of a primary optics according to FIG. 1, wherein the TIR optics each comprises a homogenization section;

FIG. 3 a detailed perspective view on the back of the primary optics of FIG. 2;

FIG. 4 a schematic cross section of another exemplary primary optics, wherein the primary optics comprises a plurality of collimator lenses as light forming devices; and

FIG. 5 part of an exemplary light module comprising a primary optics according to FIGS. 1 and 2, and a projection lens system.

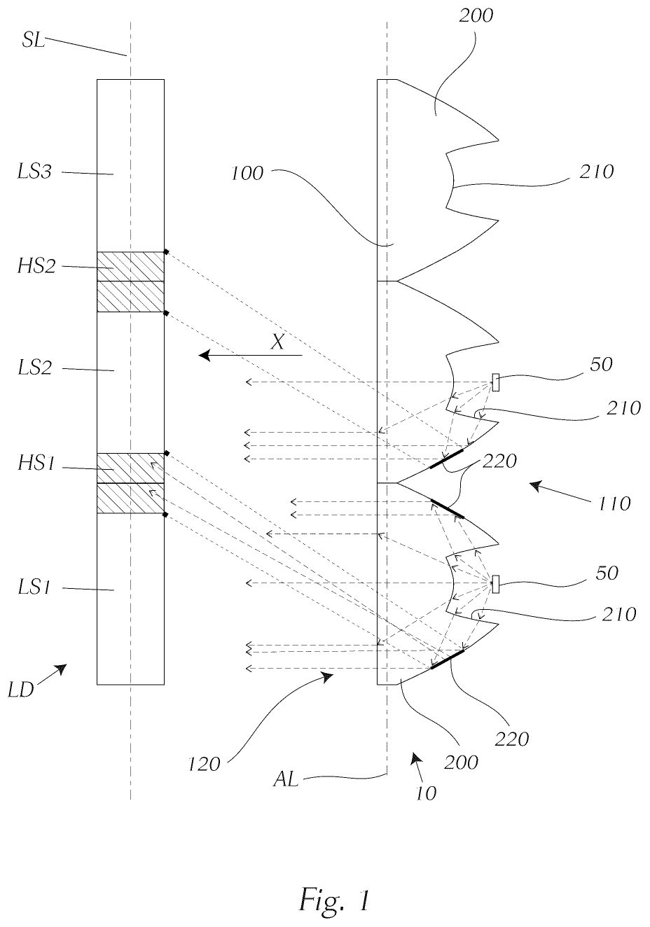

FIG. 1 shows a primary optics 10 for a light module 20 of a vehicle headlamp, the primary optics 10 is a non-imaging primary optics configured to contribute in irradiate a homogenous segmented light distribution LD in front of the primary optics 10.

The segmented light distribution LD is formed from a plurality of light segments LS1, LS2, LS3 arranged next to each other along a straight line SL in the segmented light distribution LD.

The primary optics 10 comprises a base body 100 comprising a light entry side 110, which is configured to receive light from at least one light source 50 and to couple the received light into the base body 100, and a light output side 120, which is configured to couple out light coupled into the base body 100 via the light entry side 110 in a main radiation direction X.

Further, the primary optics 10 comprises a plurality of light forming devices 200 on the light entry side 110 of the base body 100 for forming the light segments LS1, LS2, LS3 of the segmented light distribution LD, wherein each light forming device 200 has a light input section 210, into which light of at least one light source 50 can be coupled into the light forming device 200, wherein each light forming device 200 corresponds to a respective light segment LS1, LS2, LS3 of the segmented light distribution LD. The light forming devices 200 in the shown example are built as TIR optics.

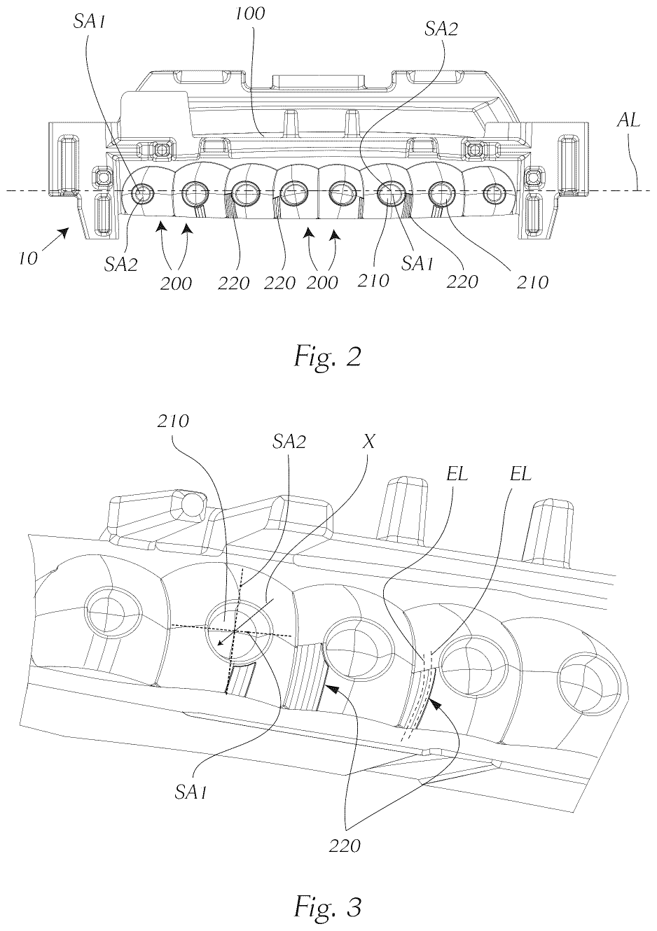

As can be seen in FIG. 1 and FIG. 2, the light forming devices 200 are aligned next to each other along a straight aligning line AL on the light entry side 110 of the base body 100.

The light segments LS1, LS2, LS3 in the segmented light distribution LD are arranged next to each other in such a way that directly adjacent light segments LS1, LS2, LS3 adjoin each other in a non-overlapping manner in a boundary area.

Further, each light forming device 200 in the shown example comprises a homogenization section 220 configured to direct part of the light coupled into the respective light forming device 200 to the boundary area of the light segments LS1, LS2, LS3 of the segmented light distribution LD in form of a homogenization segment HS1, HS2 in order to generate a homogenous segmented light distribution LD.

The homogenization section 220 comprises a structure formed of a plurality of grooves parallel to each other, wherein each of the grooves extends along an extension line EL which is substantially orthogonal to the aligning line AL, which can be seen for example in FIG. 3.

Further, the plurality of grooves of the homogenization section 220 of each light forming device 200 are arranged next to each other in such a way that the grooves together form a sinusoidal shape.

As can be seen in FIG. 2 and FIG. 3, the light input section 210 of each light forming device 200 is-seen in the main radiation direction X-symmetrical about a first symmetry axis SA 1 and about a second symmetry axis SA2, wherein the second symmetry axis SA2 is orthogonal to the first symmetry axis SA1.

The homogenization section 220 of each light forming device 200 is disposed-seen in a correct installed primary optics 10 in a vehicle headlamp-on a lower side of the first symmetry axis SA1, which can be seen in FIG. 2 for example.

The homogenization section 220 of a light forming device 200 is configured to direct the homogenization segment HS1, HS2 in a boundary area of light segments LS1, LS2, LS3 which is adjacent to the corresponding light segment LS1, LS2, LS3 of the respective light forming device 200 along the straight line SL, wherein the straight line SL is horizontally in a correct installed state of the primary optics 10 in a vehicle headlamp.

The shown primary optics 10 is created as a single pieced component by way of molding, in particular injection molding.

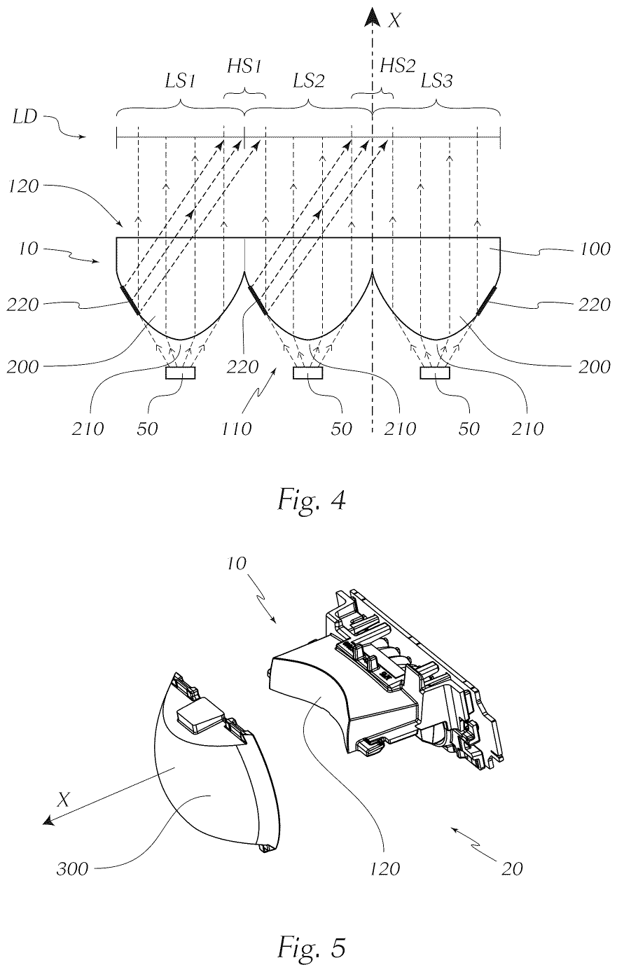

FIG. 4 shows another example of a primary optics 10, wherein the aforementioned is also applicable to the example in FIG. 4 with the exception that instead of TIR optics, each light forming device 200 is built as a collimator lens.

FIG. 5 shows an exemplary light module 20 for a vehicle headlamp comprising one primary optics 10 according to shown example in FIG. 1 and FIG. 2. Further, light module 20 comprises a plurality of light sources 50, wherein at least one light source 50 being associated with a respective light input section 210 of a light forming device 200.

Moreover, the light module 20 comprises a projection lens system 300, which is configured to receive the light emitted from the light output side 120 of the primary optics 10 and to project the segmented light distribution LD in front of the light module 20 in the main radiation direction X.

### LIST OF REFERENCE SYMBOLS

Primary optics . . . 10
Light module . . . 20
Light source . . . 50
Base body . . . 100
Light entry side . . . 110
Light output side . . . 120
Light forming device . . . 200
Light input section . . . 210
Homogenization section . . . 220
Projection lens system . . . 300
Aligning line . . . AL
Extension line . . . EL
Straight line . . . SL
Segmented light distribution . . . LD
Light segments . . . LS1, LS2, LS3
Homogenization section . . . HS1, HS2
Main radiation section . . . X

1. A primary optics (10) for a light module (20) of a vehicle headlamp, the primary optics (10) is a non-imaging primary optics configured to contribute in irradiate a homogenous segmented light distribution (LD) in front of the primary optics (10), wherein the segmented light distribution (LD) is formed from at least two light segments (LS1, LS2, LS3) arranged next to each other along a straight line (SL), wherein the primary optics (10) comprises:
a base body (100) comprising a light entry side (110), which is configured to receive light from at least one light source (50) and to couple the received light into the base body (100), and a light output side (120), which is configured to couple out light coupled into the base body (100) via the light entry side (110) in a main radiation direction (X), at least two light forming devices (200) on the light entry side (110) of the base body (100) for forming the light segments (LS1, LS2, LS3) of the segmented light distribution (LD), wherein each light forming device (200) has a light input section (210), into which light of
at least one light source (50) can be coupled into the light forming device (200), wherein each light forming device (200) corresponds to a respective light segment of the segmented light distribution (LD),
wherein the light segments (LS1, LS2, LS3) in the segmented light distribution (LD) are arranged next to each other in such a way that directly adjacent light segments (LS1, LS2, LS3) adjoin each other in an overlapping manner in a boundary area, characterized in that
at least one light forming device (200) comprises at least one homogenization section (220) configured to direct part of the light coupled into the respective light forming device (200) to the boundary area of the light segments (LS1, LS2, LS3) of the segmented light distribution (LD) in form of a homogenization segment (HS1, HS2), in order to generate a homogenous segmented light distribution (LD).

2. Primary optics according to claim 1, wherein the primary optics (10) comprises a plurality of light forming devices (200).

3. Primary optics according to claim 1, wherein each light forming device (200) comprises at least one homogenization section (220).

4. Primary optics according to claim 1, wherein the light forming devices (200) are aligned next to each other along at least one straight aligning line (AL) on the light entry side (110) of the base body (100).

5. Primary optics according to claim 1, wherein the homogenization section (220) comprises a structure formed of a plurality of grooves parallel to each other, wherein each of the grooves extends along an extension line (EL) which is substantially orthogonal to the aligning line (AL).

6. Primary optics according to claim 5, wherein the plurality of grooves of the homogenization section (220) of each light forming device (200) are arranged next to each other in such a way that the grooves together form a sinusoidal shape.

7. Primary optics according to claim 1, wherein the light input section (210) of each light forming device (200) is—seen in the main radiation direction (X)—symmetrical about at least a first symmetry axis (SA1).

8. Primary optics according to claim 7, wherein the light input section (210) of each light forming device (200) is-seen in the main radiation direction (X)-symmetrical about a second symmetry axis (SA2), wherein the second symmetry axis (SA2) is orthogonal to the first symmetry axis (SA1).

9. Primary optics according to claim 7, wherein the homogenization section (220) of each light forming device (200) is disposed—seen in a correct installed primary optics in a vehicle headlamp-on a lower side of the first symmetry axis (SA1).

10. Primary optics according to claim 1, wherein the at least one homogenization section (220) of a light forming device (200) is configured to direct the homogenization segment (HS1, HS2) in a boundary area of light segments (LS1, LS2, LS3) which is adjacent to the corresponding light segment of the respective light forming device (200) along the straight line (SL), wherein preferably the straight line (SL) is horizontally in a correct installed state of the primary optics in a vehicle headlamp.

11. Primary optics according to claim 1, wherein the light forming devices (200) are built as TIR optics or collimator lens.

12. Primary optics according to claim 1, wherein the primary optics (10) is created as a single pieced component by way of molding, in particular injection molding.

13. Light module for a vehicle headlamp comprising
at least one primary optics (10) according to claim 1,
a plurality of light sources (50), at least one light source (50) being associated with a respective light input section (210) of a light forming device (200), and
a projection lens system (300), which is configured to receive the light emitted from the light output side (120) of the primary optics (10) and to project the segmented light distribution (LD) in front of the light module (20) in the main radiation direction (X).

14. Vehicle headlamp comprising at least one light module (20) according to claim 13.
